(19) United States
(12) Patent Application Publication
(10) Pub. No.: US 2003/0210007 A1
(43) Pub. Date: Nov. 13, 2003

(54) Input power control device

(76) Inventors: Chia-Chang Hsu, Hsinchu (TW); Yen-John Chen, Changhua (TW); Chih-Shih Yang, Hsinchu (TW)

Correspondence Address: RABIN & CHAMPAGNE, PC, 1101 14TH STREET, NW, SUITE 500, WASHINGTON, DC, 20005, US

(21) Appl. No.: 10/425,874

(22) Filed: Apr. 30, 2003

(30) Foreign Application Priority Data
May 8, 2002 (TW) 091109602

(51) Int. Cl. H02P 7/00

(52) U.S. Cl. 318/440

(57) ABSTRACT

An input power control device for controlling the electrical power fed into the driven device from the power supply is provided. The power control device includes a driving device, a voltage detector, a current detector, a multiplier, and a power controller. The voltage detector detects the output voltage of the power supply, while the current detector detects the drive current fed into the driven device from the driving device. The multiplier multiplies the voltage signal and the current signal together to obtain the present electrical power input to the driven device. If the present input power of the driven device is too high, the power controller outputs an adjustment signal to the driving device to decrease the drive current of the driven device until the input power is equal to the rated value.

This application claims the benefit of Taiwan application Serial No. 091109602, filed on May 8, 2002.

### BACKGROUND OF THE INVENTION

1. Field of the Invention

The invention relates in general to a power adjusting device, and more particularly to an input power control device.

2. Description of the Related Art

Any driven device has to be driven by a driving device. For example, a motor control system has to cooperate with a relatively precise driving device to meet the design requirements, regardless of whether a constant-torque mode or a constant-speed control mode is employed. The motor can have various uses. For example, in order to decrease the system temperature in a circuit system with a higher degree of element integration, it is practical to provide a cooling fan to control the environment temperature within a proper range, thereby stabilizing circuit operations. The operational properties of the fan motor play an important role in stabilizing the fan operation. Therefore, many research and development groups direct their attention to gradually improving the operational performance of fan motors.

The input power that a motor can withstand is limited, and if the electrical power input to the motor exceeds design limits, the motor can become over-heated and burn out. For example, if the user connects a motor, which is configured to operate at a voltage of 110V, to a power source having a voltage of 220V, the motor withstands power that is two times the designed value, which will cause the motor to burn out. In other words, a motor that is configured to operate at 110V may not be connected to a 220V power supply. If a motor is designed to be used with 110V and 220V, the hardware specifications of the motor, such as the wire diameter, number of loops, and the like, must be designed according to the voltage of 220V. Accordingly, the manufacturing cost of the motor is increased.

### SUMMARY OF THE INVENTION

It is therefore an objective of the invention to provide an input power control device capable of providing a constant input power to a driven device using various power supplies. Accordingly, the driven device can operate normally with various power supplies.

The invention achieves the above-identified objective by providing an input power control device, which is described in the following.

The input power control device can control the electrical power fed into the driven device from the power supply. The power control device includes a driving device, a voltage detector, a current detector, a multiplier, and a power controller. The voltage detector detects the voltage magnitude of the power supply supplied to the driven device and outputs a voltage signal to the multiplier according to the detected voltage. The current detector detects the magnitude of the drive current supplied from the driving device to the driven device and then outputs a current signal to the multiplier according to the detected drive current. The multiplier multiplies the voltage signal and the current signal together to obtain the present electrical power fed into the driven device and to output the power signal to the power controller accordingly. In this way, a determination is made as to whether the input power of the driven device is too high. If the input power is too high, the power controller outputs an adjustment signal to the driving device to decrease the drive current of the driven device until the input power is equal to the rated value.

Other objectives, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a block diagram showing an input power control device according to a preferred embodiment of the invention.

FIG. 2 is a block diagram showing an input power control device used in an alternating current system.

FIG. 3 is a block diagram showing the power controller of FIG. 1.

### DETAILED DESCRIPTION OF THE INVENTION

In order to make the driven device operate with various power sources at specific rated input power, the power source voltage (i.e., the input voltage of the driven device) is first detected according to the invention. Then, the detected power source voltage and the drive current of the driven device are multiplied to obtain the actual input power. Next, the actual input power and the rated input power of the driven device are compared, and if the input power is higher than the rated value, the drive current is lowered until the input power matches the rated value, satisfying the input power requirements of the driven device. Conversely, if the actual input power is lower than the rated value, the drive current is increased until the input power matches the rated value.

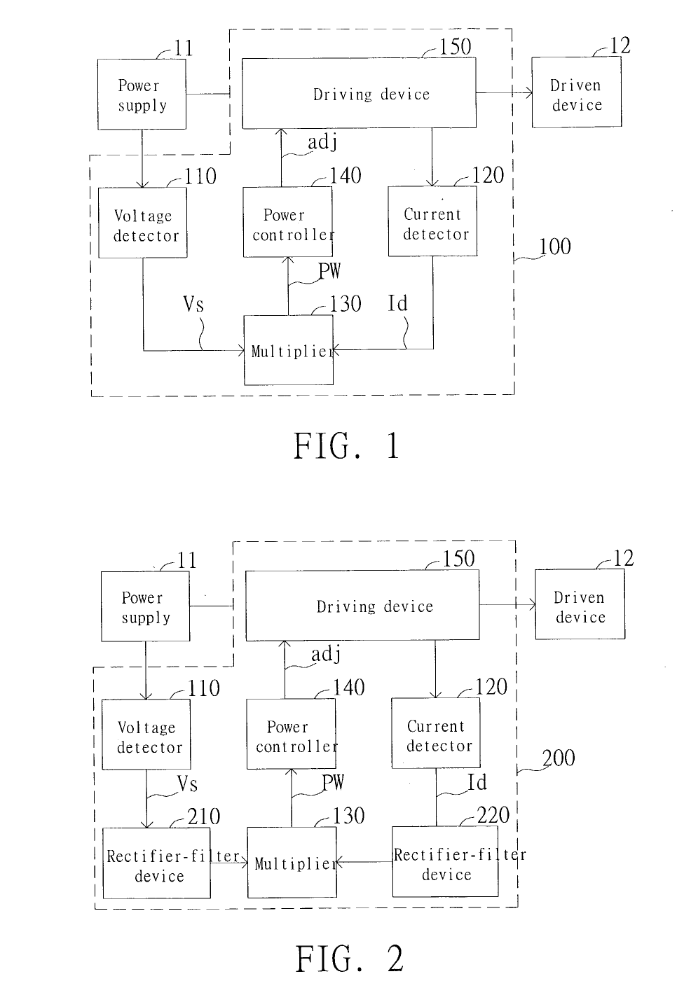

Please refer first to FIG. 1, which is a block diagram showing an input power control device according to a preferred embodiment of the invention. The power supply 11 can provide a power source necessary for the operation of the driven device 12. The driven device 12 may be a motor or a fan motor, for example. The input power control device 100 includes a driving device 150, a voltage detector 110, a current detector 120, a multiplier 130, and a power controller 140. The voltage detector 110 detects the voltage magnitude (for example, 110V or 220V) supplied by the power supply 11 to the driven device 12 and then outputs a voltage signal Vs to the multiplier 130 according to the detected voltage. The current detector 120 also detects the magnitude of the drive current supplied by the driving device 150 to the driven device 12, and then outputs a current signal Id to the multiplier 130 according to the detected drive current. The multiplier 130 multiplies the voltage signal Vs and the current signal Id together to obtain the level of electrical power input to the driven device 12, and output a power signal PW to the power controller 140 accordingly. After the power controller 140 receives the power signal PW, it judges whether or not the present input power of the driven device 12 is higher than the rated value. If the input power is too high, the power controller 140 will feed a proper adjustment signal adj into the driving device 150 so as to decrease the drive current of the driven device 12. The current signal Id output from the current detector 120 changes in response to the decrease of the drive current. The power signal PW output from the multiplier 130 can thus indicate the change of the input power after the drive current decreases. If the input power is still high, the power controller 140 will continuously change the adjustment signal adj until the input power is equal to the rated value. Conversely, if the input power is lower than the rated value, the drive current will be adjusted in an opposite manner to bring the input power back in line with the proper value.

If the driven device 12 uses alternating current, a rectifier-filter device can be utilized to get the effective value of the input power, the method of which will be described with reference to FIG. 2. Please refer to FIG. 2, which is a block diagram showing an input power control device applicable to an alternating current system. As compared to FIG. 1, rectifier-filter devices 210 and 220 are added to the input power control device 200. Because the power supply 11 supplies an alternating voltage, the voltage signal Vs output from the voltage detector 110 can be filtered by the rectifier-filter device 210 and then converted into an effective value so as to facilitate the power calculation. Similarly, the drive current fed into the driven device 12 from the driving device 150 is also alternating current, and the current signal Id output from the current detector 120 can be filtered by the rectifier-filter device 220 and then converted into the effective value. Consequently, the multiplier 130 multiplies together the voltage signal Vs and the current signal Id, and then outputs the power signal PW corresponding to the effective input power so as to facilitate the magnitude adjustment of the drive current.

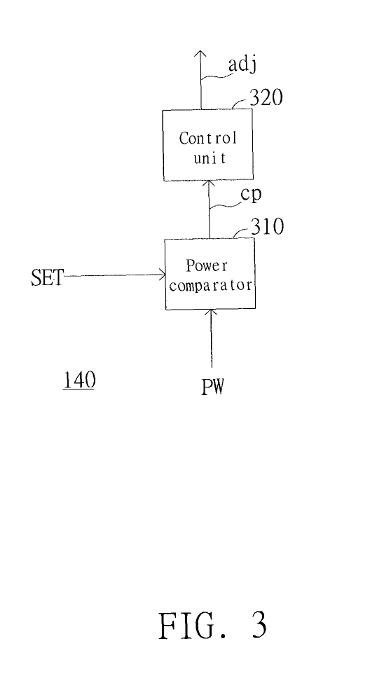

FIG. 3 is a block diagram showing the power controller of FIG. 1. The power controller 140 includes a power comparator 310 and a control unit 320. The power comparator 310 receives the power signal PW, compares the power signal PW with a predetermined power signal SET, and outputs a comparison signal cp to adjust the magnitude of the drive current accordingly. For example, the predetermined power signal SET may be the rated input power of the driven device 12. If the power signal PW is greater than the predetermined power signal SET, the actual input power exceeds the rated value. In this case, a negative comparison signal cp is output to decrease the drive current and thus the input power. Conversely, if the actual input power is smaller than the rated value, a positive comparison signal cp will be output to increase the input power. On receiving the comparison signal cp, the control unit 320 outputs a proper corresponding adjustment signal adj according to the magnitude of the comparison signal cp. The driving device 150 thus adjusts the drive current according to the adjustment signal adj, thereby achieving the goal of controlling the input power. In actual applications, the control unit 320 can be designed to use a PWM (pulse width modulation) controller.

While the invention has been described by way of examples and in terms of preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An input power control device for controlling an input power of a driven device, the driven device obtaining a power source, which is necessary for operation, from a power supply, the input power control device comprising:
a driving device for supplying a drive current necessary for the driven device to operate;
a current detector coupled to the driving device for outputting a current signal according to the drive current;
a voltage detector coupled to the power supply for outputting a voltage signal according to an output voltage from the power supply;
a multiplier coupled to the voltage detector and the current detector for outputting a power signal according to the voltage signal and the current signal; and
a power controller coupled to the multiplier and the driving device for outputting an adjustment signal according to the power signal so as to cause the driving device to adjust the drive current according to the adjustment signal.

2. The input power control device according to claim 1, further comprising a rectifier-filter device coupled to the voltage detector for filtering the voltage signal and then outputting the filtered voltage signal.

3. The input power control device according to claim 1, further comprising a rectifier-filter device coupled to the current detector for filtering the current signal and then outputting the filtered current signal.

4. The input power control device according to claim 1, wherein the driven device is a motor.

5. The input power control device according to claim 1, wherein the power controller comprises:
a power comparator for comparing the power signal with a predetermined power signal and then outputting a comparison signal; and
a control unit coupled to the power comparator for outputting the adjustment signal according to the comparison signal.

6. The input power control device according to claim 5, wherein the control unit is a pulse width modulation (PWM) controller.

7. The input power control device according to claim 5, further comprising a rectifier-filter device coupled to the voltage detector for filtering the voltage signal and then outputting the filtered voltage signal.

8. The input power control device according to claim 5, further comprising a rectifier-filter device coupled to the current detector for filtering the current signal and then outputting the filtered current signal.

9. The input power control device according to claim 5, wherein the driven device is a motor.
